(19) United States
(12) Patent Application Publication
(10) Pub. No.: US 2011/0127322 A1
(43) Pub. Date: Jun. 2, 2011

(54) ELECTRONIC APPARATUS

(75) Inventor: Gen WATANABE, Akishima-shi (JP)

(73) Assignee: KABUSHIKI KAISHA TOSHIBA, Tokyo (JP)

(21) Appl. No.: 12/955,309

(22) Filed: Nov. 29, 2010

(30) Foreign Application Priority Data
Nov. 30, 2009 (JP) 2009-272629

(51) Int. Cl. G06F 17/00

(52) U.S. Cl. 235/375

(57) ABSTRACT

According to one embodiment, an electronic apparatus includes a reader, a setting module, a determination module, and a processing module. The reader configured to read first and second data from first and second recording medium. The setting module configured to set function setup data in which the first data, which is read from the first recording medium by the reader, is associated with data indicative of content of a process. The determination module configured to determine whether the second data, which is read from the second recording medium by the reader, agrees with the first data. The processing module configured to perform a process, based on the data which is indicative of the content of the process and is associated with the first data, when the determination module determines that the second data agrees with the first data.

### CROSS-REFERENCE TO RELATED APPLICATIONS

This application is based upon and claims the benefit of priority from Japanese Patent Application No. 2009-272629, filed Nov. 30, 2009; the entire contents of which are incorporated herein by reference.

### FIELD

Embodiments described herein relate generally to an electronic apparatus which non-contactly reads data which is recorded in a recording medium such as an RF tag.

### BACKGROUND

In recent years, electronic apparatuses, which read data by making use of RFID technologies, have been gaining in popularity. According to the RFID, data, which is recorded in a semiconductor memory mounted in an RF tag (also referred to as an RFID tag, a wireless tag, or an ID tag), can non-contactly be read out by an RF reader. For example, an individual identification code (tag ID), which is unique to an object (an article, an animal, a person, etc.) that is to be managed, is recorded in the RF tag. If the RF tag is attached to the object, the object can be identified by reading the tag ID from the RF tag by means of the RF reader.

For example, a portable RF tag information processing terminal, which is disclosed in Jpn. Pat. Appln. KOKAI Publication No. 2001-266085, has a structure which is suited to read data from RF tags attached to goods stacked in warehouses or in shops, RF tags attached to shelves of goods, or RF tags attached to the ears of domestic animals such as cattle. This information processing terminal has such a structure that an antenna for communication with the RF tag and the body of the information processing terminal are coupled by an extensible antenna holding module which can hold the antenna and the body in a separate state. Thereby, even in the case of an RF tag which is attached to a moving object (e.g. domestic animal), the antenna can easily be brought close to the RF tag and data can be read.

As has been described above, in the electronic apparatus using the conventional RFID technology, the individual identification code (tag ID) is read from the RF tag that is attached to the object, and the identification and management of the object (e.g. commercial product) are performed based on the individual identification code. In other words, in the conventional electronic apparatus, the individual identification code, which is read from the RF tag, is used simply as the object of a process such as a recording process, a classification process or a totaling process, and the individual identification code is not used for functional control.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an external appearance view showing the structure of an electronic apparatus according to an embodiment;

FIG. 2 is an exemplary block diagram showing the system configuration of a personal computer according the embodiment;

FIG. 3 is an exemplary diagram showing the place where the personal computer according the embodiment is used;

FIG. 4 is an exemplary flow chart illustrating a function setup process in the embodiment;

FIG. 5 is an exemplary diagram showing function setup data which is set by the function setup process in the embodiment;

FIG. 6 is an exemplary flow chart illustrating a function execution process in the embodiment;

FIG. 7 is an exemplary diagram showing the use of the personal computer according the embodiment; and

FIG. 8 is an exemplary diagram showing the use of the personal computer according the embodiment.

### DETAILED DESCRIPTION

Various embodiments will be described hereinafter with reference to the accompanying drawings.

In general, according to one embodiment, an electronic apparatus includes a reader, a setting module, a determination module, and a processing module. The reader configured to read first and second data from first and second recording medium. The setting module configured to set function setup data in which the first data, which is read from the first recording medium by the reader, is associated with data indicative of content of a process. The determination module configured to determine whether the second data, which is read from the second recording medium by the reader, agrees with the first data. The processing module configured to perform a process, based on the data which is indicative of the content of the process and is associated with the first data, when the determination module determines that the second data agrees with the first data.

An embodiment will now be described with reference to the accompanying drawings.

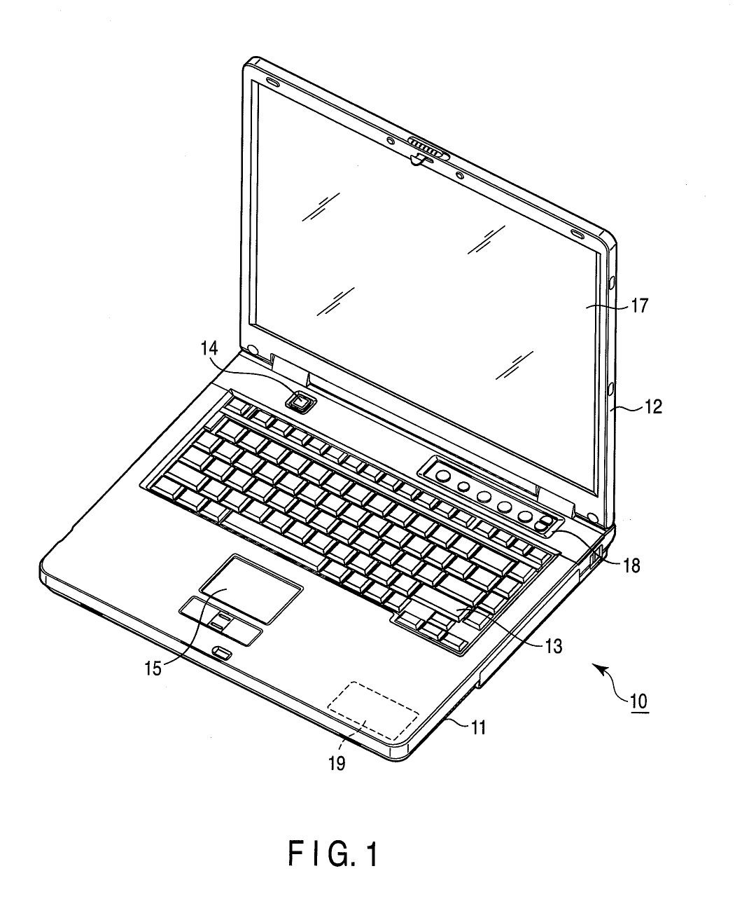

FIG. 1 is an external appearance view showing the structure of an electronic apparatus according to embodiment. This electronic apparatus is realized, for example, as a notebook-type portable personal computer 10. The personal computer 10 in the embodiment can be carried with battery driving.

FIG. 1 is a perspective view showing the personal computer 10 in the state in which a display unit thereof is opened. The personal computer 10 comprises a computer main body 11 and a display unit 12. A display device that is composed of an LCD (Liquid Crystal Display) 17 is built in the display unit 12. A display screen of the LCD 17 is disposed at a substantially central part of the display unit 12.

The display unit 12 is attached to the computer main body 11 such that the display unit 12 is freely rotatable between an open position and a closed position. The computer main body 11 has a thin box-shaped casing to which a battery is detachably attached.

A keyboard 13, a power button switch 14 for power on/off, a touch pad 15 and general-purpose hardware buttons 18 are disposed on the top surface of the computer main body 11. The general-purpose hardware buttons 18 comprise, for example, a plurality of buttons which are composed by using touch sensors. By the setup of programs, different functions can be assigned to the respective buttons. In addition, an RF tag reader 19 is provided, for example, on the bottom part of the computer main body 11.

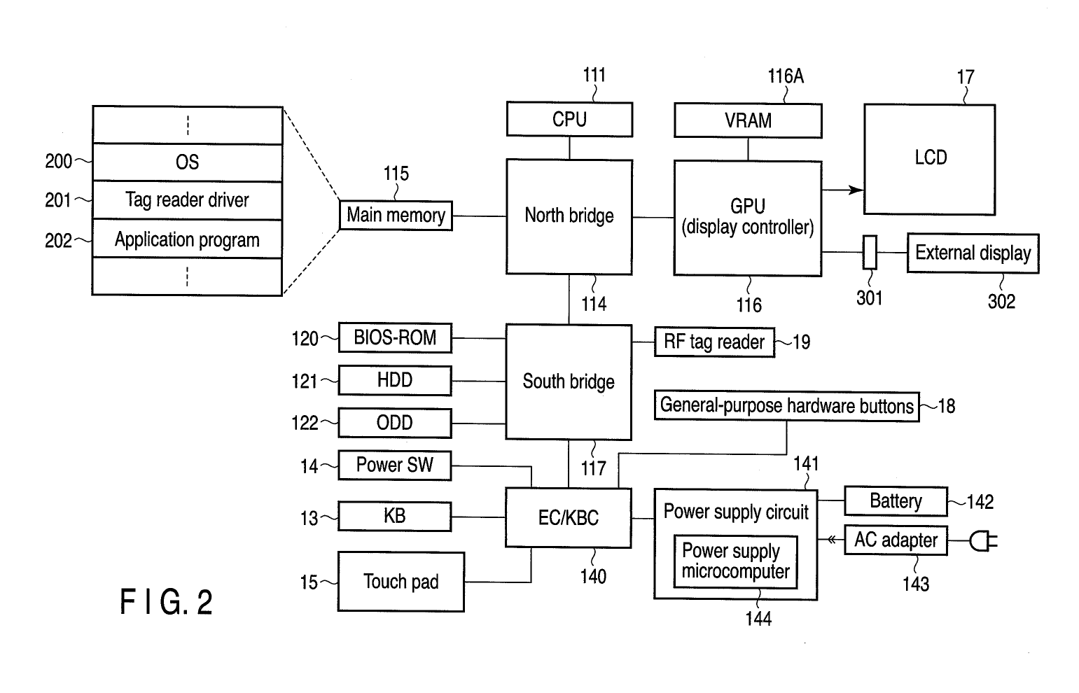

Next, referring to FIG. 2, the system configuration of the personal computer 10 according to the embodiment is described.

As shown in FIG. 2, the personal computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, an embedded controller/keyboard controller IC (EC/KBC) 140, a power supply circuit 141, and an RF tag reader 19.

The CPU 111 is a processor which is provided in order to control the operation of the personal computer 10. The CPU 111 executes an operating system (OS) 200, drivers for controlling various hardware, and various application programs, which are loaded from the HDD 121 into the main memory 115. The application programs include a Web browser, a music playback program, a mailer, and a communication program. In addition, in the embodiment, the CPU 111 executes a tag reader driver 201 which controls the RF tag reader 19, a function setup process program for executing a function setup process which will be described later, a function execution process for executing a function execution process, and a program for executing function control of various hardware.

Furthermore, the CPU 111 executes a system BIOS (Basic Input/Output System) which is stored in the BIOS-ROM 120. The system BIOS is a program for hardware control.

The north bridge 114 is a bridge device which connects a local bus of the CPU 111 and the south bridge 117. The north bridge 114 includes a memory controller which access-controls the main memory 115.

The GPU 116 is a display controller for controlling the LCD 17 which is used as a display monitor of the personal computer 10, and an external display 302 such as a CRT. The external display 302 is connected, where necessary, to an external video output terminal 301 which is provided on the computer main body 11.

The GPU 116 executes a display process (graphics arithmetic process) for drawing frames on the video memory (VRAM) 116A, based on a drawing request which is sent from CPU 111 via the north bridge 114.

The south bridge 117 incorporates an IDE (Integrated Drive Electronics) controller and a Serial ATA controller for controlling the HDD 121 and optical disc drive (ODD) 122.

The embedded controller/keyboard controller IC (EC/KBC) 140 is a 1-chip microcomputer in which an embedded controller for power management and a keyboard controller for controlling the keyboard (KB) 13, touch pad 15 and general-purpose hardware buttons 18 are integrated. The general-purpose hardware buttons 18 can change the functions which are assigned to the buttons by the setup of the program. The EC/KBC 140 has a function of powering on/off the personal computer 10 in response to the user's operation of the power button switch 14. The power-on/off control of the personal computer 10 is executed by the cooperation between the EC/KBC 140 and power supply circuit 141.

The power supply circuit 141 generates and supplies operation power to the respective components by using power from the battery 142 which is attached to the computer main body 11, or power from an external power supply which is connected via the AC adapter 143. The power supply circuit 141 is provided with a power supply microcomputer 144. The power supply microcomputer 144 monitors the power supply (charge/discharge) to the respective components and battery 142, and the charging state of the battery 142.

The RF tag reader 19 is connected to the south bridge 117 via, e.g. a USB (Universal Serial Bus) controller. The RF tag reader 19 non-contactly reads data (e.g. tag ID) from the RF tag by the control of the tag reader driver 201. An IC chip is built in the RF tag, and data is recorded in a recording medium in the IC chip.

Although not shown in FIG. 2, it is assumed that the personal computer 10 is provided with a module (audio controller, speaker) for outputting audio, a communication module which communicates with an external device, and a camera module which captures an image (video).

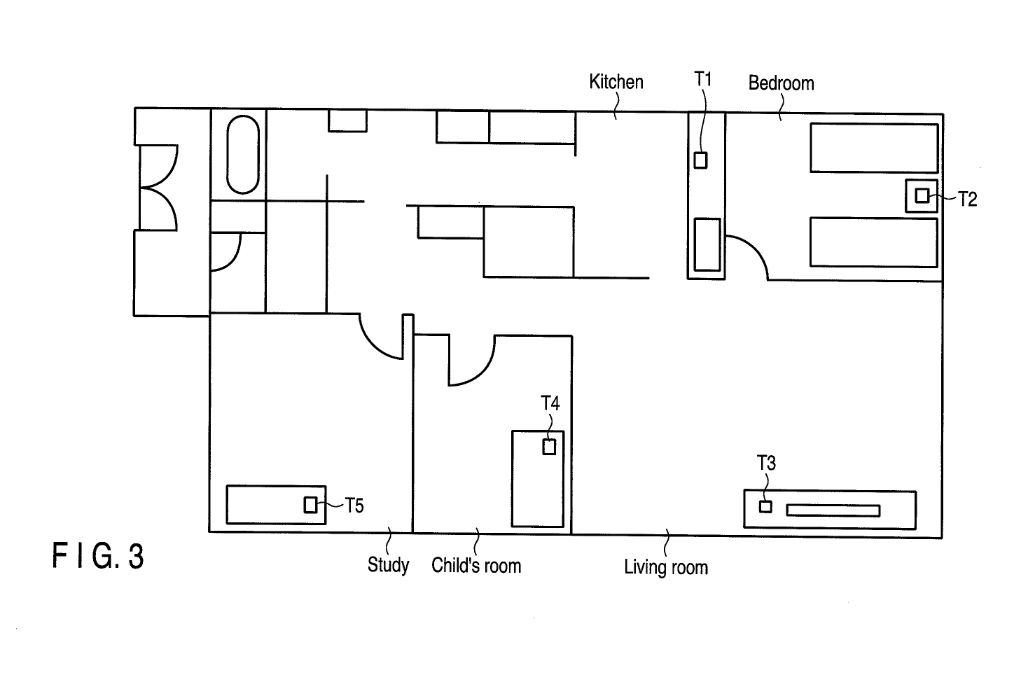

FIG. 3 shows an example of a place where the personal computer 10 of the embodiment is used.

FIG. 3 shows a layout of a general house, which includes a kitchen, a bedroom, a living room, a child's room, and a study. In the example shown in FIG. 3, an RF tag T1 is disposed in the kitchen. Similarly, an RF tag T2 is disposed on a sideboard in the bedroom, an RF tag T3 is disposed in the living room, an RF tag T4 is disposed in the child's room, and the RF tag T5 is disposed in the study.

From the RF tags T1 to T5, unique tag information (tag ID) is read by the RF tag reader 19 which is provided on the personal computer 10. Since the RF tags T1 to T5 require no external power supply, the user can dispose them at arbitrary locations. In the meantime, the RF tags T1 to T5 may be either of an active type in which batteries are built, or a passive type in which power is generated by electromagnetic induction.

In the personal computer 10 of the embodiment, the function control is automatically executed according to the tag IDs which are read from the RF tags T1 to T5, and the operations corresponding to the locations where the RF tags T1 to T5 are disposed can be performed. Thus, simply by moving the personal computer 10 to the places where the RF tags T1 to T5 are disposed, the functions to be executed can be switched.

FIG. 3 shows the example in which the RF tags are used in the general house. However, since the RF tags requires no power supply, the RF tags can be used in various places such as an office, a factory, a shop and a school, if the RF tags can be disposed in such places.

Next, the operation of the personal computer 10 in the embodiment is described.

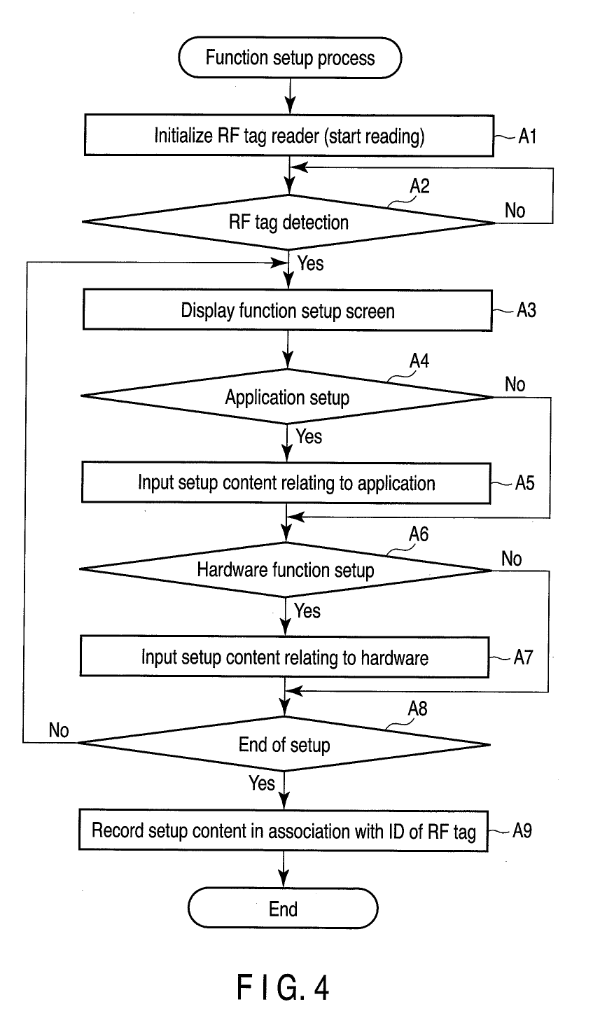

FIG. 4 is a flow chart illustrating a function setup process by the personal computer 10. The function setup process is a process for setting up the contents of the function execution process, which is executed by the personal computer 10, by associating the function control with the tag IDs which are read from the RF tags T1 to T5.

If execution of the function setup process is instructed by the user, the CPU 111 starts the function setup program. The CPU 111 initializes the RF tag reader 19 by the tag reader driver 201, and starts a read operation (block A1).

For example, in the case where a specific function is to be executed by the personal computer 10 in the kitchen, an arbitrary tag (RF tag T1 in this example) is disposed in the kitchen. The user carries the personal computer 10 into the kitchen, and instructs the execution of the function setup process.

If the RF tag T1 is detected by the RF tag reader 19 and the tag ID “01h” is read out from the RF tag T1 (Yes in block A2), the CPU 111 causes the LCD 17 to display a screen for function setup (block A3).

On the function setup screen, arbitrary selection can be made with respect to, for example, the selection of an application to be executed, the designation of setup information which is referred to when each application is executed, and the function setup for the hardware in which a setup change can be performed by the program.

If the setup of the application is instructed on the function setup screen (Yes in block A4), the CPU 111 displays the screen for application selection, and inputs data indicative of setup content relating to the application which is designated by the user through this screen (block A5).

In this case, one of a plurality of applications installed in the personal computer 10 can arbitrarily be selected through the function setup screen. Besides, two or more applications may be designated, and the order of execution of the applications may be designated. The setup content according to the selected application can arbitrarily be designated.

For example, when a Web browser has been selected, the URL (uniform resource indicator) address of a Web site, which is to be accessed when the Web browser is started, can be designated as setup information. In addition, when a music playback program has been selected, the designation and playback mode of music content to be played back can be set as setup information. Besides, setup information corresponding to each of selected applications can be designated.

If the setup of hardware is instructed on the function setup screen (Yes in block A6), the CPU 111 displays a screen for hardware setup, and inputs setup content relating to the hardware which is designated by the user through the screen (block A7).

The function control of the hardware, which can be set up, includes, for example, luminance control of the LCD 17 or external display 302, setup of the functions which are assigned to the general-purpose hardware buttons 18, setup of the output/stop or the volume of audio from speakers, and power-saving setup (including power-off). In addition, the function control of hardware, which can be executed by the program, may be set to be the object of setup.

In this case, the function control of hardware, which can be set up, may arbitrarily be selected. The function controls of plural hardware may be set to be the objects of setup, and the order of execution of function controls may be designated. Besides, the setup content corresponding to the function control of selected hardware can arbitrarily be designated.

For example, when the luminance control of the display has been selected, the luminance of the screen and the time up to turn-off of the screen display can be designated as setup information. When the setup of the functions assigned to the general-purpose hardware buttons 18 has been selected, the functions which are assigned to plural buttons included in the general-purpose hardware buttons 18 can be designated as setup information, for example, such that the plural buttons are used as buttons for use in operating the application which has been set in the application setup. Specifically, in the function setup of hardware, it is possible to execute setup as to how specific hardware is caused to function, while the application which has been designated by the application setup is being executed.

If the end of setup for the application and hardware is instructed (Yes in block A8), the CPU 111 generates function setup data by associating the tag ID “01h”, which has been read from the RF tag T1, and the data indicative of the setup content which has been designated by the user, and the CPU 111 records the generated function setup data in a nonvolatile recording medium, such as the HDD 121, and completes the function setup process (block A9).

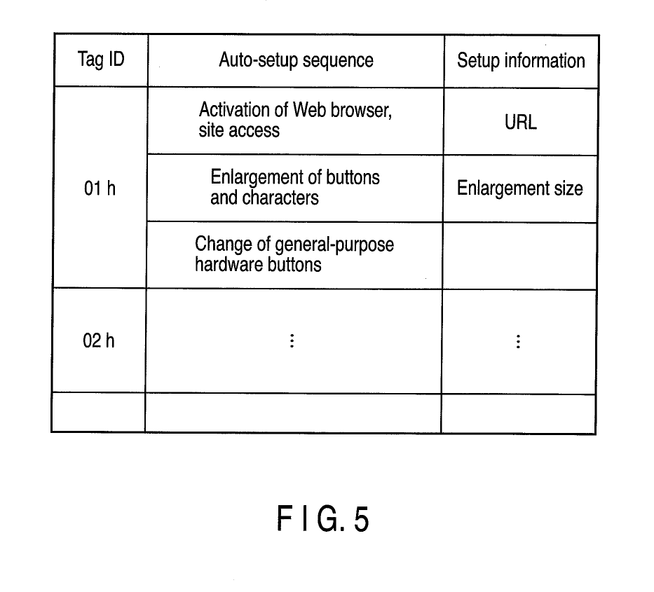

FIG. 5 shows an example of the function setup data which has been set by the function setup process.

As show in FIG. 5, auto-setup sequence data and setup information, which are indicative of the setup contents designated by the user, are set in association with the tag IDs which are read from the RF tags. FIG. 5 illustrates that the setup contents are set in association with the tag IDs (01h, 02h, . . . ) which are read from plural RF tags T1 to T5.

The auto-setup sequence data is data which defines the procedure of a process which is to be executed when the tag ID has been read from the RF tag. In the auto-setup sequence data, the application to be executed and the process content of the application, as well as the contents of the function setup for the hardware implemented in the personal computer 10, are set in the order of processes to be executed.

For example, in the auto-setup sequence which is set for the tag ID “01h” in FIG. 5, the access to a prescribed Web site by the “Web browser” is set. Following this, designated are the enlargement/change of buttons and characters displayed on the LCD 17, and changes of the functions assigned to the general-purpose hardware buttons 18.

The URL (uniform resource locator) address of the Web site to be accessed is set as setup information relating to the activation of the “Web browser”. The enlargement size is set as setup information relating to the enlargement/change of buttons and characters.

In this manner, in the function setup process, the function setup can arbitrarily be executed for the personal computer 10 in association with the RF tags T1 to T5. In the case where the user wishes to perform a specific function of the personal computer 10 at a specific location, it should suffice if the user disposes the RF tag at the location and causes the personal computer 10 to execute the function setup process.

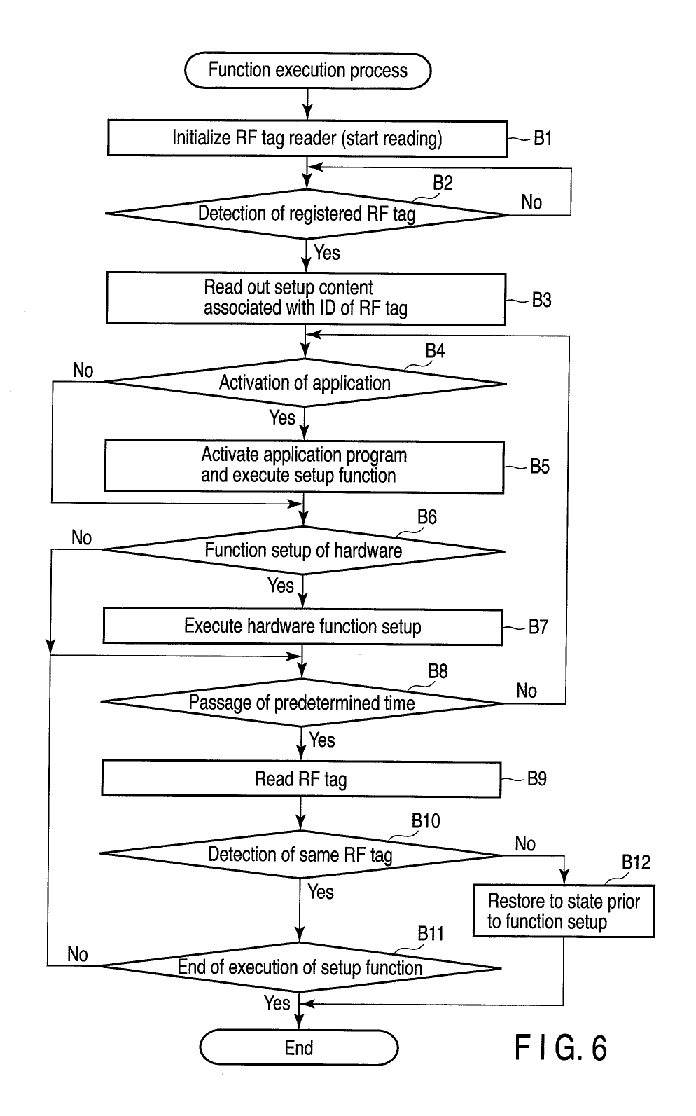

Next, referring to a flow chart of FIG. 6, a description is given of a function execution process by the personal computer 10 in the embodiment. The function execution process is a process for executing function control of the personal computer 10 in accordance with the function setup which is set in association with the tag ID that has been read from the RF tag.

If execution of the function execution process is instructed by the user, the CPU 111 starts the function execution program. The CPU 111 initializes the RF tag reader 19 by the tag reader driver 201, and starts a read operation (block B1).

If the tag ID is read from the RF tag by the RF tag reader 19, the CPU 111 determines whether the read tag ID agrees with the tag ID which is already registered in the function setup data. If the tag IDs do not agree and function setup data for the read tag ID has not yet been registered (No in block B2), the read ID is not set to be the object of the function execution and the read operation by the RF tag reader 19 is continued (block B3).

On the other hand, if the read tag ID is determined to be already registered in the function setup data (Yes in block B2), the CPU 111 reads out the setup content that is set in the function setup data, in association with the read tag ID, and starts the function execution corresponding to the setup content.

If the execution of the application is set in the auto-setup sequence (Yes in block B4), the CPU 111 starts the associated application program through the operating system 200 in response to the request from the function execution program, and causes the application program to execute the function corresponding to the setup information (block B5).

If the function setup of the hardware is set in the auto-setup sequence (Yes in block B6), the CPU 111 starts a program relating to the function setup of the hardware, such as an associated control program or device driver of the hardware, through the operating system 200 in response to the request from the function execution program, and executes the function setup of the hardware in accordance with this setup information (block B7).

In the auto-setup sequence, it is also possible to execute setup relating to the activation of the application, the timing of the start of execution of the specific function, or the timing of the end thereof. For example, with reference to the time when the tag ID, which is already registered in the function setup data, has been read, the timing of the start/end of execution can be designated. Similarly, the timing of the start/end of execution of the function setup of hardware can be designated.

The CPU 111 controls the function setup of the application and hardware in accordance with the timing of the start/end of execution, which is set in the auto-setup sequence.

Each time a preset predetermined period has passed (e.g. at intervals of five minutes) (Yes in block B8), the CPU 111 executes the read of the RF tag by the RF tag reader 19 (block B9). When the same tag ID as the tag ID that is the object of the function execution has been read (Yes in block B10), the function execution process is continued.

Specifically, the CPU 111 determines whether the personal computer 10 is continuously disposed at the location of the function execution (i.e. the location where the RF tag, from which the tag ID has been read, is disposed). If the personal computer 10 is disposed at the same location, the function setup relating to the application started by the function execution process and the function setup relating to the hardware are kept effective.

On the other hand, when the same tag ID as the tag ID that is the object of the function execution has not been read (No in block B10) by the read operation by the RF tag reader 19 (block B8), the CPU 111 determines that the position of the personal computer 10 has been moved, and the CPU 111 terminates the application that was started by the function execution process, restores the function setup of the hardware to the state prior to the function execution process, and completes the function execution process (block B12).

In the meantime, the time interval, at which the read of the RF tag is executed, may arbitrarily be set by the user.

Besides, if the execution of the setup function is finished without the movement of the position of the personal computer 10 (Yes in block B11), the CPU 111 completes the function execution process.

Concrete examples of the function execution process are described below.

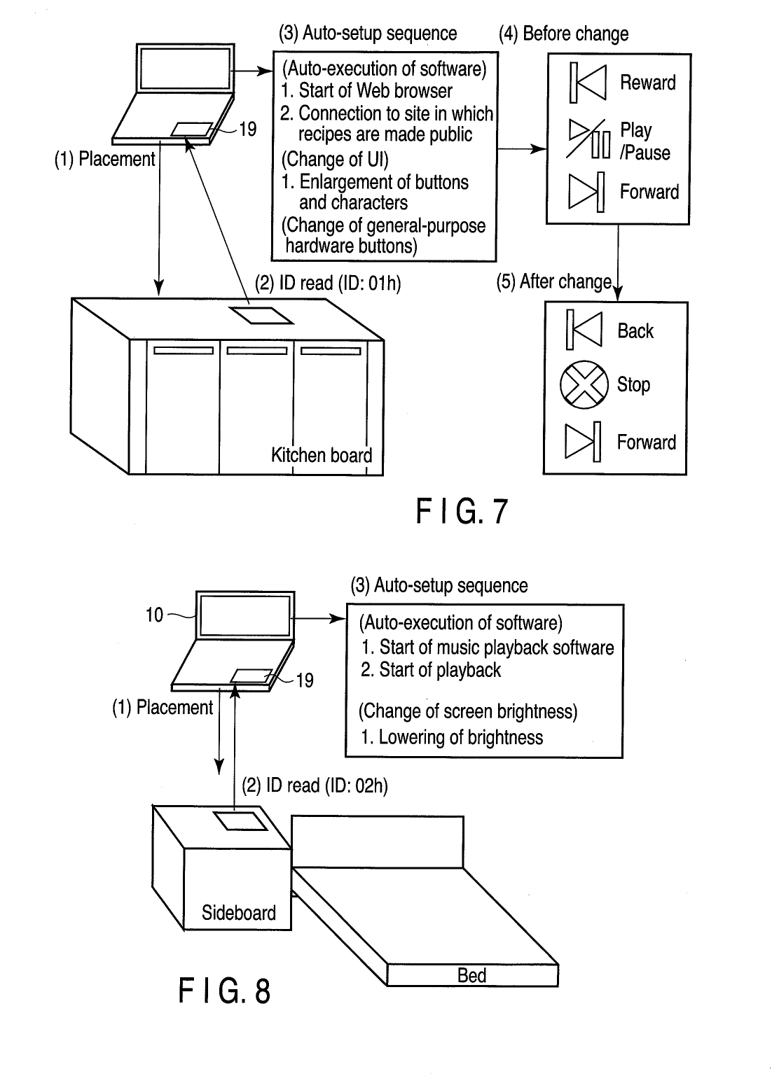

FIG. 7 shows an example in which the personal computer 10 is used in the kitchen shown in FIG. 3. It is assumed that the RF tag of the tag ID “01h” is attached in advance on the kitchen board of the kitchen, and the function setup data shown in FIG. 5 is set.

The user places the personal computer 10, in which the function execution process has been started, on the kitchen board ((1) in FIG. 7). The personal computer 10 can read the tag ID “01h” from the RF tag T1, which is attached to the kitchen board, by means of the RF tag reader 19 ((2) in FIG. 7).

The personal computer 10 executes the auto-setup sequence which is set in association with the tag ID “01h” ((3) in FIG. 7). To start with, the personal computer 10 activates the Web browser, and executes connection to a Web site which is indicated by the URL address designated by the setup information. For example, if a Web site, in which cooking recipes are made public, is designated, the personal computer 10, which is carried into the kitchen, automatically accesses the Web site and can display the Web page on the LCD 17.

In addition, function setup for altering the user interface is executed, and buttons and characters, which are displayed on the LCD 17, are enlarged. Thereby, it becomes easy to confirm the Web page of the cooking recipes displayed on the LCD, while working in the kitchen.

Further, the functions assigned to the respective general-purpose hardware buttons 18 are changed. Normally, the functions for a music playback program are assigned to the respective general-purpose hardware buttons 18, as shown in part (4) of FIG. 7 which illustrates the assignment of the functions before the change. This assignment of the functions is changed such that the functions which are most suited to the viewing of the Web browser, that is, the functions of “Back”, “Stop” and “Forward”, are assigned to the buttons which are disposed at easy-to-operate positions. Thereby, the Web browser can be operated by the general-purpose hardware buttons 18, and not by the touch pad 15 or keyboard 13.

In this manner, if the function control of the hardware is designated in association with the application, it is possible to provide not only simple switching of functions, but also an operational environment which is suited to the condition of use.

FIG. 8 shows an example in which the personal computer 10 is used in the bedroom shown in FIG. 3. The RF tag of the tag ID “02h” is attached on the sideboard of the bedroom.

The user places the personal computer 10, in which the function execution process has been started, on the sideboard ((1) in FIG. 8). The personal computer 10 can read the tag ID “02h” from the RF tag T2, which is attached to the sideboard, by means of the RF tag reader 19 ((2) in FIG. 8).

The personal computer 10 executes the auto-setup sequence which is set in association with the tag ID “02h” ((3) in FIG. 8). To start with, in the function execution relating to the application, the personal computer 10 activates the music playback program, and starts playback according to the playback mode that is designated in the setup information. In addition, if music content that is a target of playback is designated, this music content is played back.

In addition, the luminance of the LCD 17 is lowered by the function control for the hardware, so that the bedroom may not become too bright.

With the personal computer 10 being carried into the bedroom, music, which the user wishes to listen to before sleeping, is played back, and the luminance of the display is lowered so that the bedroom may not become too bright and sleep may not be prevented. In the meantime, if the time of stop of the music playback program is designated as setup information, the playback by the music program can automatically be stopped when the time of stop has passed, and the personal computer 10 can be powered off.

As has been described above, if the personal computer 10 (electronic apparatus) of the embodiment is brought to the place where the RF tag, T1 to T5, is attached, the functions corresponding to the RF tag, T1 to T5, can automatically be executed. Since the personal computer 10 executes not only the application, but also the function control of the hardware, the useful operability and environment of the entire system can be provided to the user. In the embodiment, since the RF tags which require no external power supply are used, the place where the personal computer 10 can be used is not strictly restricted, and may easily be changed.

In the above description, the personal computer 10 is provided with the RF tag reader 19, and the function setup of the personal computer 10 is changed by reading the tag IDs from the RF tags T1 to T5. Alternatively, some other wireless communication function may be implemented in the personal computer 10, and unique data which is recorded in other recording media may non-contactly (wirelessly) be read, and, based on the read data, the same processes (function setup process, function execution process) as described above may be executed.

In the above description, the personal computer 10 is employed as the electronic apparatus. Alternatively, other portable electronic apparatuses, such as a mobile phone, a digital camera and a music player, may be employed as the electronic apparatus.

In the above description, the function execution process is activated by the user designation during the operation of the personal computer 10. Alternatively, the function execution process may be activated in the following manner. For example, even when the personal computer 10 is in the non-operative state in the power-saving mode (e.g. standby mode or sleep mode), such a mode is set that the RF tag can be read by the RF tag reader 19. When the registered tag ID is read by the function setup process at the time of this mode, the personal computer 10 is powered on (so-called “wakeup”), and the above-described function execution process is executed.

The description has been given of the case in which the personal computer 10 is provided with the RF tag reader 19 and the tag ID is read from the RF tag. Alternatively, the personal computer 10 may be provided with an RF tag reader/writer, and specific data may be written in the RF tag in the function setup process. In this case, in the function setup process, the data written in the RF tag, as well as the tag ID, may read out and may be used in the function execution process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a reader configured to read first and second data from first and second recording media;
a setting module configured to set function setup data in which the first data, which is read from the first recording medium by the reader, is associated with data indicative of content of a process;
a determination module configured to determine whether the second data, which is read from the second recording medium by the reader, corresponds with the first data; and
a processing module configured to perform a process, based on the data which is indicative of the content of the process and is associated with the first data, if the determination module determines that the second data corresponds with the first data.

2. The electronic apparatus of claim 1, further comprising:
an input module configured to input the data indicative of the content of the process in order to associate with the first data.

3. The electronic apparatus of claim 1, wherein the data indicative of content of the process comprises data indicative of execution of an application program.

4. The electronic apparatus of claim 1, wherein the data indicative of content of the process comprises data indicative of function setup for hardware.

5. The electronic apparatus of claim 1, wherein the reader is configured to periodically read the second data, and
the processing module is configured to terminate the process, if the second data is unable to be read by the reader.

6. The electronic apparatus of claim 1, wherein the reader is a radio-frequency (RF) tag reader, wherein the first and second data are RF identifiers, and wherein the first and second recording media are RF tags.

7. The electronic apparatus of claim 1, wherein the reader is configured to read the first and second data from the first and second recording media wirelessly.

8. A method of setting function setup data of an electronic apparatus, the method comprising:
reading first and second data from first and second recording media;
setting the function setup data in which the first data, which is read from the first recording medium by the reader, is associated with data indicative of content of a process;
determining whether the second data, which is read from the second recording medium, corresponds with the first data; and
performing a process, based on the data which is indicative of the content of the process and is associated with the first data, if the determination module determines that the second data corresponds with the first data.

9. The method of claim 8, further comprising:
inputting the data indicative of the content of the process in order to associate with the first data.

10. The method of claim 8, wherein the data indicative of content of the process comprises data indicative of execution of an application program.

11. The method of claim 8, wherein the data indicative of content of the process comprises data indicative of function setup for hardware.

12. The method of claim 8, further comprising:
periodically reading the second data, and
terminating the process, if the second data is unable to be read.

13. The method of claim 8, further comprising:
reading the first and second data from the first and second recording media wirelessly.
